(19) United States
(12) Patent Application Publication
(10) Pub. No.: US 2021/0166716 A1
(43) Pub. Date: Jun. 3, 2021

(54) IMAGES GENERATED BASED ON EMOTIONS

(71) Applicant: Hewlett-Packard Development Company, L.P., Spring, TX (US)

(72) Inventors: Samuel Yung, Vancouver, WA (US); Joseph Howard, Vancouver, WA (US)

(21) Appl. No.: 17/048,040

(22) PCT Filed: Aug. 6, 2018
(86) PCT No.: PCT/US2018/045336

§ 371 Date: Oct. 15, 2020

(51) Int. Cl. G10L 21/10; G10L 25/63; G06F 3/12; G06T 11/20; G10H 1/00

(52) U.S. Cl. CPC G10L 21/10; G10L 25/63; G06F 3/1204; G06F 3/1244; G10H 2240/085; G06T 11/20; G10H 1/0008; G10H 2220/005; G10H 2220/131; G06F 3/1285

(57) ABSTRACT

In example implementations, an apparatus is provided. The apparatus includes a communication interface, a sentiment analysis component, a vocal analysis component, and a processor communicatively coupled to the communication interface, the sentiment analysis component, and the vocal analysis component. The communication interface is to receive a phrase captured by a printer. The sentiment analysis component identifies an emotion of a user based on the phrase. The vocal analysis component converts the phrase into X-Y coordinates of a coordinate plane. The processor generates an image based on the emotion and the X-Y coordinates and transmits the image to the printer via the communication interface.

### BACKGROUND

Individuals live busy lives that can be very stressful. For example, parents can be stressed from the daily grind of getting children ready for school, commuting to work, problems that arise at work, shuttling children to and from activities, and the like. Individuals can cope with stress in a variety of different ways. For example, some individuals may get a massage, some individuals may meditate, and so forth.

### BRIEF DESCRIPTION OF THE DRAWINGS

FIG. 1 is a block diagram of an example system to generate images based on emotions of a user of the present disclosure;

FIG. 2 is a block diagram of an example apparatus to generate the image based on emotions of the user of the present disclosure;

FIG. 3 is a flow chart of an example method for generating an image based on an emotion of a user; and

FIG. 4 is a block diagram of an example non-transitory computer readable storage medium storing instructions executed by a processor to generate an image based on an emotion of a user; and

FIG. 5 is a block diagram of an example non-transitory computer readable storage medium storing instructions executed by a processor to receive an image based on an emotion of a user to be printed.

### DETAILED DESCRIPTION

Examples described herein provide an apparatus that generates images based on emotions of a user. The images can be used by individuals as a coloring image to provide relaxation and stress relief. In one example, the image may be generated based on identified emotions of a user.

Examples herein include a printer (e.g., a two dimensional printer or a three dimensional printer) that is enabled with voice detection and a network connection. The printer may prompt a user to speak a word or a phrase. The phrase may be captured and transmitted to a server in a network that generates emotional resonance images based on analysis of the phrase spoken by the user. The emotional resonance image may be a Mandala image that can be used as an adult coloring page to provide relaxation.

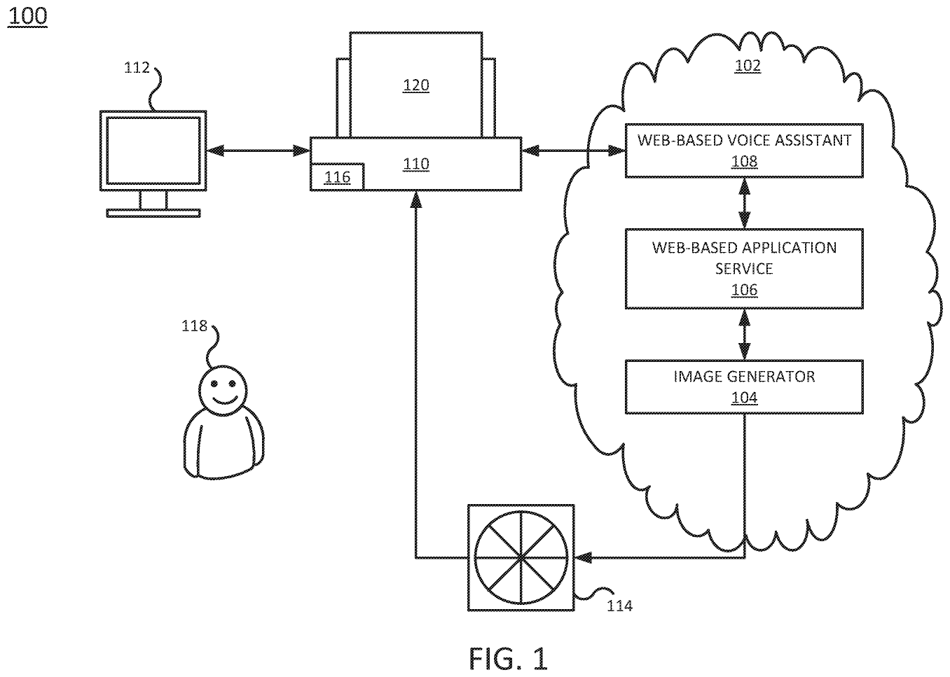

FIG. 1 illustrates a block diagram of a system 100 of the present disclosure. In one example, the system 100 may include an Internet protocol (IP) network 102. The IP network 102 has been simplified for ease of explanation and may include additional network elements that are not shown. For example, the IP network 102 may include additional access networks, border elements, gateways, routers, switches, firewalls, and the like.

In one example, the IP network 102 may include an image generator 104, a web-based voice assistant 108, and a web-based application service 106. In one example, the web-based voice assistant 108, the web-based application service 106, and the image generator 104 may be communicatively coupled to one another over the IP network 102.

In one example, the web-based voice assistant 108 may be a service that works in coordination with a voice assistant application that is executed on an endpoint device. The web-based voice assistant 108 may receive voice commands for execution from the endpoint device that are sent over the IP network 102 to the web-based voice assistant 108 for execution. Examples of the web-based voice assistant 108 may include Google™ Asisstant, Siri™ Cortana™, Amazon Alexa™, and the like.

In one example, the web-based application service 106 may provide services to connect web-based applications (e.g., the web-based voice assistant 108) with third party applications or services. In one example, the web-based application service 106 may include services such as Macedon™ Web Services. The web-based application services 106 may allow the web-based voice assistant 108 to work with the image generator 104.

In one example, the image generator 104 may be a remotely located server or computing device located in the IP network 102. The image generator 104 may generate an image 114 based on emotions of a user 118. The image 114 may be a Mandala image that can be used to relieve stress of the user 118. For example, the image 114 may be colored for relaxation.

In one example, the system 100 may include a printer 110 that is connected to the IP network 102. The printer 110 may be connected to the IP network 102 via a wired or wireless connection.

The printer 110 may include a microphone 116. The microphone 116 may be integrated with the printer 110. In another example, the microphone 116 may be external to the printer 110. For example, the microphone 116 may be connected via universal serial bus (USB) connection to printer 110 or may be a mobile endpoint device wirelessly connected to the printer 110. For example, an application executed on a smart phone of the user 118 may record a phrase spoken by the user and wirelessly transmit the recording of the phrase to the printer 110.

In one example, the printer 110 may be communicatively coupled to a display 112. In one example, the display 112 may be part of the printer 110. In another example, the display 112 may be an external display. For example, the display 112 may be a monitor or part of a computing system (e.g., a desktop computer, a laptop computer, and the like).

In one example, the user 118 may activate the web-based voice assistant 108 by speaking a wake command that is captured by the microphone 116. The web-based voice assistant 108 may then prompt the user 118 to speak a phrase via a speaker on the printer 110 or a computing device connected to the printer 110. The phrase may be any sentence, group of words, a word, and the like, that the user 118 wishes to speak.

In one example, the phrase spoken by the user 118 may be captured by the microphone 116 and recorded by the printer 110. A recording of the phrase may then be transmitted to the web-based voice assistant 108 over the IP network 102. The phrase may then be transmitted to the image generator 104 via the web-based application service 106.

The image generator 104 may then analyze the phrase to identify an emotion of the user 118. Based on an emotion of the user 118, the image generator 104 may generate the image 114. Further details of the analysis are described below.

The image 114 may be transmitted to the printer 110. The printer 110 may display the image 114 via the display 112 for a preview. The user 118 may then accept the image 114 to be printed or reject the image 114 and request a new image 114 to be generated. If the image 114 is accepted, the image 114 may be printed by the printer 110 on a print media 120. The print media 120 may be paper.

If the image 114 is rejected, the image generator 104 may attempt to generate a new image 114. In another example, the user 118 may be prompted to speak a new phrase and the new image 114 may be generated by the image generator 104 based on the emotion identified in the newly spoken phrase.

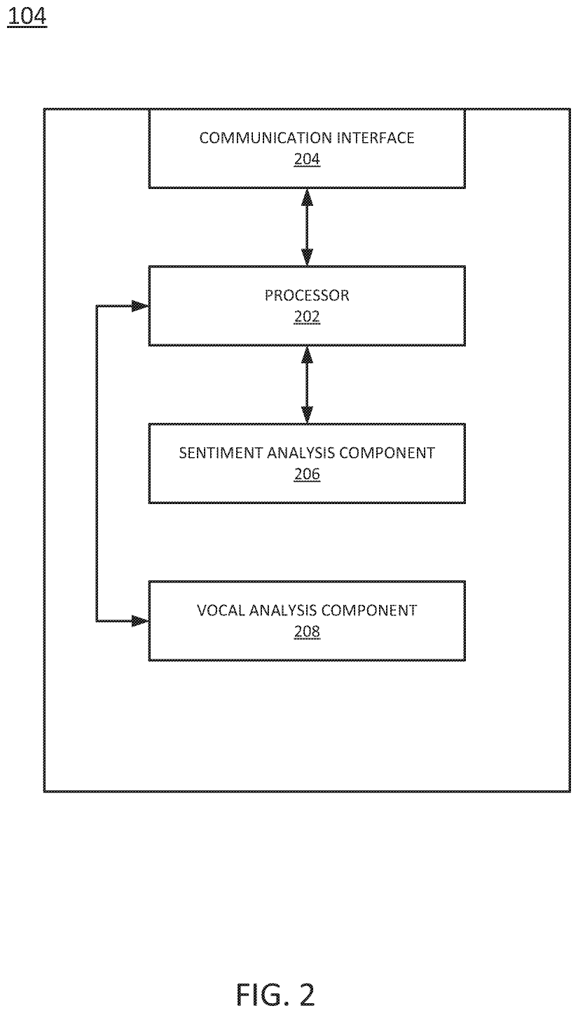

FIG. 2 illustrates an example of the image generator 104. In one example, the image generator 104 may include a processor 202, a communication interface 204, a sentiment analysis component 206, and a vocal analysis component 208. The processor 202 may be communicatively coupled to the communication interface 204, the sentiment analysis component 206, and the vocal analysis component 208.

In one example, the communication interface 204 may be a wired or wireless interface. For example, the communication interface 204 may be an Ethernet interface, a Wi-Fi radio, and the like. The image generator 104 may receive a phrase spoken by the user 118 via the communication interface 204. The phrase may be recorded and the data packets associated with the recording may be transmitted to the image generator 104 via the communication interface 204.

In one example, the sentiment analysis component 206 may identify an emotion of the user 118 based on the phrase. In one example, the emotion may be based on a score rating calculated from the phrase by the sentiment analysis component 206.

In one example, the sentiment analysis component 206 may calculate the score rating as a value of (−10 to +10). The score rating may be calculated based on a comparison of the words in the phrase spoken by the user 118 and a value assigned to words in a pre-defined list of possible emotion based words. In one example, the pre-defined list may be an AFINN sentiment lexicon list. In one example, the image generator 104 may include a computer readable memory that stores a table that includes the pre-defined list of words and the associated integer values or respective scores of each word.

The AFINN list provides a list of English words rated for valence with an integer. Positive words can be assigned positive integers and negative words can be assigned negative integers. The more positive the value of the score rating, the more positive the emotion of the user 118 (e.g., happy, excited, etc.). The more negative the value of the score rating, the more negative the emotion of the user 118 (e.g., angry, mad, unhappy, etc.). A score rating of 0 may be identified as a neutral emotion (e.g., content).

The score rating may be provided to the sentiment analysis component 206 to identify the emotion of the user 118. For example, if the score rating is determined to be +8, the emotion of the user 118 may be identified as positive or happy. The emotion may be also referred to as a mood value. The mood value may be used to select from three groups of predefined images. Each group of predefined images may include two images. Each group may be associated with a different emotion or mood value. For example, one set of images may be associated with a negative emotion or mood value, one set of images may be associated with a positive emotion or mood value, and one set of images may be associated with a neutral emotion or mood value.

The images selected based on the emotion may be placed on an X-Y coordinate plane associated with the print media 120. For example, the dimensions of the print media 120 may determine the size of the X-Y coordinate plane. The X-Y coordinate plane may be the largest area of 36-degree pie-slice areas that can fit onto the dimensions of the print media 120.

As noted above, the sentiment analysis component 206 may calculate the score rating. The sentiment analysis component 206 may also calculate a value for a comparative rating. The values for the score rating and the comparative rating may be converted into X-Y coordinates that determine a portion of the selected image that may be defined to generate the image 114.

In one example, the comparative rating may be calculated based on a sum of the integer values for each word in the phrase and a total number of words. For example, the phrase may include five words. The words in the phrase may be compared to the AFINN list and the sum of the values of the integers of each word may be determined to be +10. The comparative rating may be calculated to be 2 (e.g., 10/5=2).

In one example, the voice analysis component may calculate values of a frequency and a midi signature by converting the phrase into a musical note. The frequency and the midi signature may be converted into X-Y coordinates with the score rating and the comparative rating.

In one example, to convert the phrase into a musical note, a step (e.g., a musical step), an alteration (e.g., a musical alteration), and an octave may be calculated. The step may be calculated by a total length of the phrase (e.g., a total number of letters) then modulus of a maximum step value. The alteration may be calculated by converting each character or letter in the phrase into Unicode then modulus a maximum alteration value. The octave may be calculated by converting each character or letter into a hexadecimal then modulus a maximum octave value. In one example, the step, the alteration, and the octave of the phrase may be delivered to a note parser to return a frequency value and a midi signature value.

Thus, through the vocal analysis component 208 and the sentiment analysis component 206, five values can be calculated (e.g., the score rating, the mood/emotion, the comparative score, the frequency, and the midi signature). The score rating, the comparative rating, the frequency, and the midi signature can then be converted into X-Y coordinates to select a portion of the pre-defined image that was selected based on the mood/emotion of the user 118.

In one example, the score rating, the comparative rating, the frequency, and the midi signature may be divided by a maximum value of the score rating, the comparative rating, the frequency, and the midi signature and multiplied by a maximum size of the X-Y coordinate plane based on the print media 120. The first X-Y coordinate pair may be the resulting value based on the frequency and the score rating (e.g., the frequency may be the X coordinate and the score rating may be the Y coordinate). The second X-Y coordinate pair may be the resulting value based on the midi signature and the comparative rating (e.g., the midi signature may be the X coordinate and the comparative rating may be the Y coordinate).

The first X-Y coordinate pair may be used to set the location of the first image of the two images that are selected based on the mood value/emotion of the user 118. The first X-Y coordinate pair may be used to set the upper left corner of the first image at the first X-Y coordinate pair on the X-Y coordinate plane.

The second X-Y coordinate pair may be used to set the location of the second image of the two images that are selected based on the mood value/emotion of the user 118. The second X-Y coordinate pair may be used to set the upper left corner of the second image at the second X-Y coordinate pair on the X-Y coordinate plane. The first image and the second image may overlap one another on the X-Y coordinate plane.

In one example, the image generator 104 may also include a multiply filter. The processor 202 may control the multiply filter to combine the overlapping first image and second image into a single composite image. For example, the multiply filter may make the top layer (e.g., the second image) translucent or partially translucent to allow the lower layer (e.g., the first image) to show through.

In one example, the pre-defined area of the 36-degree pie-slice of the X-Y coordinate plane may be extracted with the portion of the composite image that is located within the area of the 36-degree pie-slice. The area of the 36-degree pie-slice with the portion of the composite image may be copied ten times in a circular fashion to form the Mandala image generated in the image 114. For example, each pie-slice may include a vertex and the vertex of each pie-slice containing the portion of the composite image may be connected to form the circular image.

The image 114 may then be transmitted back to the printer 110 via the communication interface 204. For example, the image 114 may be transmitted to the web-based application service 106 via the IP network 102. The web-based application service 106 may then transmit the image 114 to the printer 110. The printer 110 may display the image 114 on the display 112 to allow the user 118 to preview the image 114 as described above. The user 118 may then select a command of accept, cancel, redo, or no (e.g., such as by physically interacting with a user interface, or issuing a verbal command, by way of non-limiting example).

“Accept” may cause the image 114 to be printed on the print media 120 by the printer 110. “Cancel” may exit the application. “Redo” may request the image 114 to be regenerated. In one example, the image 114 may be regenerated by adding a random value to each X-Y coordinate value calculated above. For example, adding the random value may cause a different pie-slice of the composite image to be captured. The different pie-slice may be repeated in a circular fashion to generate a new image 114 based on the emotion of the user 118. The new image 114 may then be transmitted back to the printer 110. “No” may cause the entire process to be repeated beginning with speaking a new phrase.

Thus, the system 100 of the present disclosure with the image generator 104 may generate an emotional resonance image based on a phrase that is spoken by a user. The system 100 may analyze the phrase (e.g., the words chosen by a user for the spoken phrase) and detect an emotion. An image may be generated based on the emotion that is detected. The image may be printed by the printer 110 and provide a coloring image for the user 118 to help or enhance an emotion felt by the user (e.g., negative, neutral, or positive).

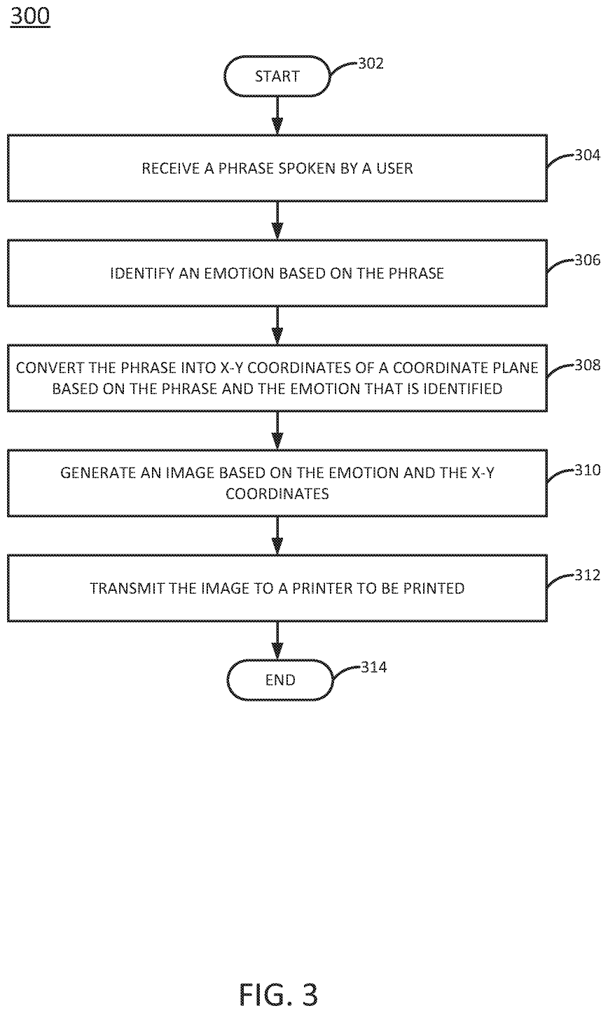

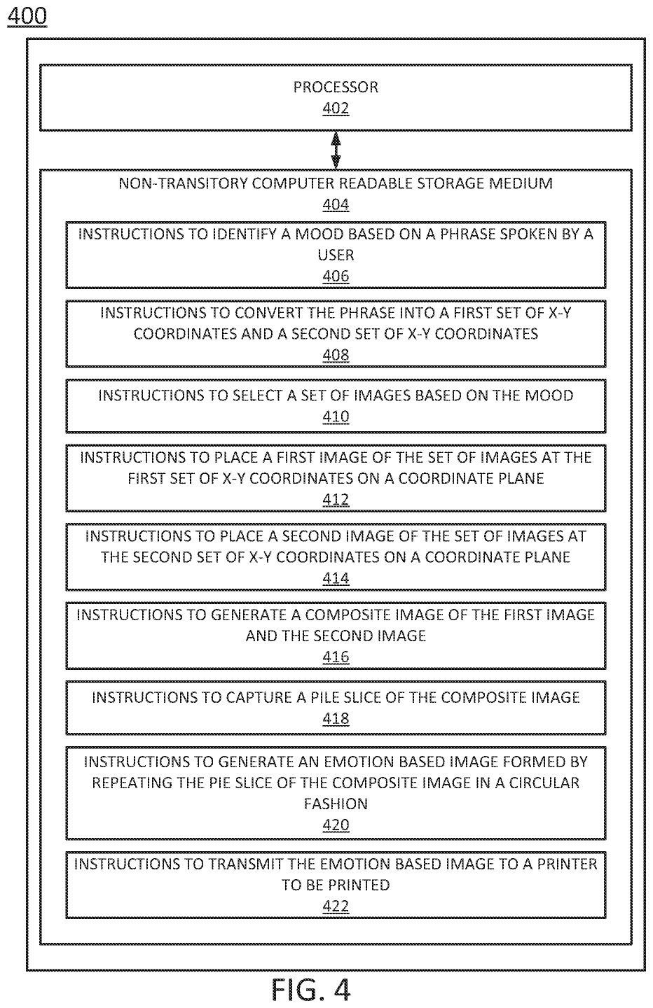

FIG. 3 illustrates a flow diagram of an example method 300 for generating an image based on an emotion of a user. In an example, the method 300 may be performed by the image generator 104 or the apparatus 400 illustrated in FIG. 4 and described below.

At block 302, the method 300 begins. At block 304, the method 300 receives a phrase spoken by a user. For example, a voice assistant application on an endpoint device of a user that is connected to a printer, or the printer itself, may execute the voice assistant application. The voice assistant application may work with a web-based voice assistant server. In one example, the user may speak a “wake” word to activate the voice assistant application followed by a command. The voice assistant application may then prompt the user to speak a phrase. The spoken phrase may be captured by a microphone and temporarily stored for transmission. For example, the spoken phrase may be temporarily stored as an audio file that can be transmitted.

At block 306, the method 300 identifies an emotion based on the phrase. In one example, the spoken phrase may be transmitted to an image generator that can analyze the phrase. A vocal analysis component in the image generator may identify a variety of different parameters such as a score rating, a comparative score, a frequency, and a midi signature. A sentiment analysis component may then identify an emotion based on the parameters. For example, the score rating may be used to determine a mood/emotion (e.g., negative, neutral, or positive).

At block 308, the method 300 converts the phrase into X-Y coordinates of a coordinate plane based on the phrase and the emotion that is identified. As described above, the phrase may be converted into a musical note by converting the phrase into a step, an alteration, and an octave. The musical note can be analyzed by a note parser to extract a frequency and a midi signature. The score rating, the comparative score, the frequency, and the midi signature may be converted into pairs of X-Y coordinates. The emotion that is detected can be used to select a set of pre-defined images associated with the emotion that is detected.

At block 310, the method 300 generates an image based on the emotion and the X-Y coordinates. As described above, a first set of X-Y coordinates may be used to place a first one of the pre-defined images associated with the emotion on an X-Y coordinate plane. The X-Y coordinate plane may be determined by a size or dimensions of a print media that is used. A second set of X-Y coordinates may be used to place a second one of the pre-defined images associated with the emotion on the X-Y coordinate plane.

The images may be overlaid on top of one another and blended. For example, a multiply filter may be used to make the second image that is on top of the first image translucent or partially translucent to allow the lower image to show through. In one example, an area of the layered images can be captured and repeated into a pattern that can form an image that is printed by the printer.

In one example, a pre-defined area of a pie-slice (e.g., a 36-degree pie-slice) may be applied over the composite image. The portion of the composite image that is located within the pre-defined area of the pie-slice may then be repeated ten times in a circular fashion to form the image. For example, each pie-slice may have a vertex and the vertex of each pie-slice having a copy of the portion of the composite image may be connected to form a circular image. The image that is formed may be a Mandala image.

At block 312, the method 300 transmits the image to a printer to be printed. For example, the Mandala image may be transmitted to the printer. The Mandala image may be shown in a display (e.g., an external display or a display associated with the printer). The user may then select one of the following options: accept, cancel, redo, or no. The actions associated with the options accept, cancel, redo, and no, are described above. At block 314, the method 300 ends.

FIG. 4 illustrates an example of an apparatus 400. In one example, the apparatus 400 may be the image generator 104. In one example, the apparatus 400 may include a processor 402 and a non-transitory computer readable storage medium 404. The non-transitory computer readable storage medium 404 may include instructions 406, 408, 410, 412, 414, 416, 418, 420, and 422 that, when executed by the processor 402, cause the processor 402 to perform various functions to generate an image based on an emotion of a user.

In one example, the instructions 406 may include instructions to identify a mood based on a phrase spoken by a user. The instructions 408 may include instructions to convert the phrase into a first set of X-Y coordinates and a second set of X-Y coordinates. The instructions 410 may include instructions to select a set of images based on the mood. The instructions 412 may include instructions to place a first image of the set of images at the first set of X-Y coordinates on a coordinate plane. The instructions 414 may include instructions to place a second image of the set of images at the second set of X-Y coordinates on the coordinate plane. The instructions 416 may include instructions to generate a composite image of the first image and the second image. The instructions 418 may include instructions to capture a pie slice of the composite image. The instructions 420 may include instructions to generate an emotion based image formed by repeating the pie slice of the composite image in a circular fashion. The instructions 422 may include instructions to transmit the emotion based image to a printer to be printed.

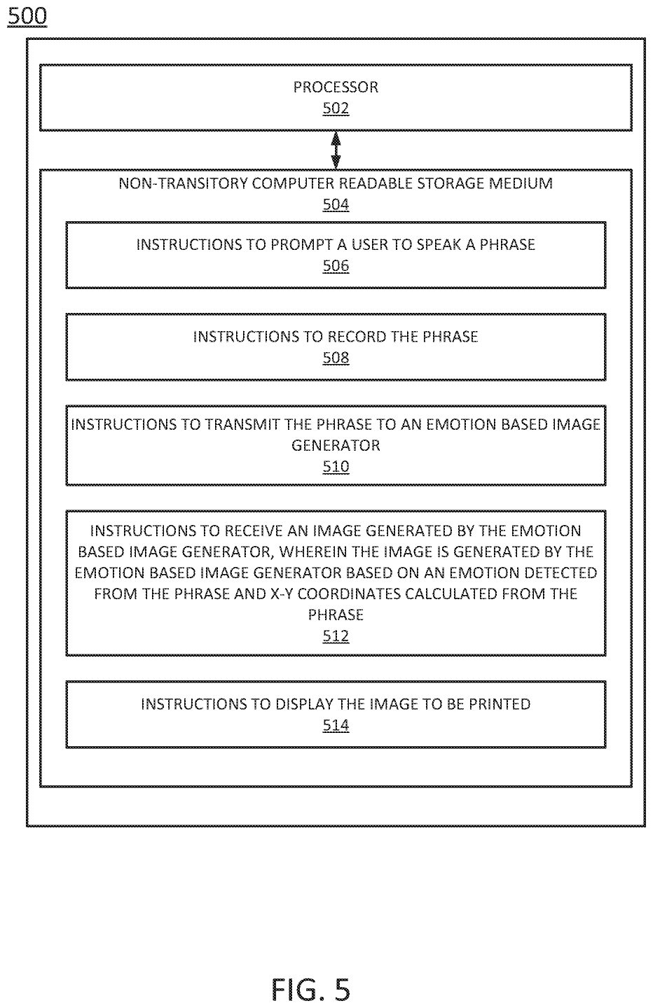

FIG. 5 illustrates an example of an apparatus 500. In one example, the apparatus 500 may be the printer 110. In one example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions to receive an image based on an emotion of a user to be printed.

In one example, the instructions 506 may include instructions to prompt a user to speak a phrase. The instructions 508 may include instructions to record the phrase. The instructions 510 may include instructions to transmit the phrase to an emotion based image generator. The instructions 512 may include instructions to receive an image generated by the emotion based image generator, wherein the image is generated by the emotion based image generator based on an emotion detected from the phrase and X-Y coordinates calculated from the phrase. The instructions 514 may include instructions to display the image to be printed.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a communication interface to receive a phrase captured by a printer;
a sentiment analysis component to identify an emotion of a user based on the phrase;
a vocal analysis component to convert the phrase into X-Y coordinates of a coordinate plane; and
a processor communicatively coupled to the communication interface, the sentiment analysis component, and the vocal analysis component, the processor to generate an image based on the emotion and the X-Y coordinates and to transmit the image to the printer via the communication interface.

2. The apparatus of claim 1, further comprising:
a memory to store a table comprising words having a respective score.

3. The apparatus of claim 2, wherein the sentiment analysis component is to calculate a score rating based on words in the phrase that match the words in the table.

4. The apparatus of claim 3, wherein the sentiment analysis component is to calculate a comparative rating based on the score rating of the words in the phrase and a total number of words in the phrase.

5. The apparatus of claim 4, wherein the vocal analysis component is to calculate a midi signature value and a frequency value of the phrase.

6. The apparatus of claim 5, wherein the vocal analysis component is to convert the phrase into a musical note to calculate a step, an alteration, and an octave of the musical note, wherein the midi signature value and the frequency value are to be calculated based on the step, the alteration, and the octave of the musical note.

7. The apparatus of claim 6, wherein a first set of the X-Y coordinates comprise the frequency value and the score rating and a second set of X-Y coordinates comprise the midi signature value and the comparative rating.

8. The apparatus of claim 7, wherein a set of images are to be selected based on the emotion, wherein a first image of the set of images is to be placed on the coordinate plane using the first set of X-Y coordinates and a second image is to be placed on the coordinate plane using the second set of X-Y coordinates.

9. The apparatus of claim 8, wherein the image comprises a Mandala image that is to be generated by capturing a portion of a combined image formed by a blend of the first image and the second image and the portion of the combined image is to be repeated in a circular fashion to form the Mandala image.

10. A non-transitory machine-readable storage medium encoded with instructions executable by a processor, the machine-readable storage medium comprising:
instructions to identify a mood based on a phrase spoken by a user;
instructions to convert the phrase into a first set of X-Y coordinates and a second set of X-Y coordinates;
instructions to select a set of images based on the mood;
instructions to place a first image of the set of images at the first set of X-Y coordinates on a coordinate plane;
instructions to place a second image of the set of images at the second set of X-Y coordinates on the coordinate plane;
instructions to generate a composite image of the first image and the second image;
instructions to capture a pie slice of the composite image;
instructions to generate an emotion based image formed by repeating the pie slice of the composite image in a circular fashion; and
instructions to transmit the emotion based image to a printer to be printed.

11. The non-transitory machine-readable storage medium of claim 10, further comprising:
instructions to capture a different pie slice of the composite image;
instructions to generate a different emotion based image formed by repeating the different pie slice in a circular fashion; and
instructions to transmit a different emotion based image to the printer to be printed.

12. The non-transitory machine-readable storage medium of claim 10, wherein a size of the X-Y coordinates is a function of a print medium used to print the emotion based image.

13. A non-transitory machine-readable storage medium encoded with instructions executable by a processor of a printing device, the machine-readable storage medium comprising:
instructions to prompt a user to speak a phrase;
instructions to record the phrase;
instructions to transmit the phrase to an emotion based image generator;
instructions to receive an image generated by the emotion based image generator, wherein the image is generated by the emotion based image generator based on an emotion detected from the phrase and X-Y coordinates calculated from the phrase; and
instructions to display the image to be printed.

14. The non-transitory machine-readable storage medium of claim 13, further comprising:
instructions to print the image when a confirmation is received that the image is accepted.

15. The non-transitory machine-readable storage medium of claim 13, further comprising:
instructions to re-send the phrase or a new phrase to the emotion based image generator to generate a new image when the image is rejected.
